(19) United States
(12) Patent Application Publication
(10) Pub. No.: US 2004/0229676 A1
(43) Pub. Date: Nov. 18, 2004

(54) Method of playing a game of chance

(76) Inventors: Gerald Duhamel, Drummondville (CA); Marie Claude Gagnon, Drummondville (CA)

Correspondence Address: LABTRONIX CONCEPT INC., C/O OGILVY RENAULT, 1981 MC GILL COLLEGE AVENUE, SUITE 1600, MONTREAL, QUEBEC, H3A 2Y3, CA

(21) Appl. No.: 10/833,269

(22) Filed: Apr. 28, 2004

Related U.S. Application Data
(60) Provisional application No. 60/465,676, filed on Apr. 28, 2003.

(51) Int. Cl. A63F 13/00

(52) U.S. Cl. 463/16

(57) ABSTRACT

A method of playing a game of chance wherein a primary game is provided. This primary game has primary game indicia organized in a structure characteristic to its type. A subset of the primary game indicia is duplicated in a structure characteristic to a secondary game. At least part of the primary game is played and elements from the primary game outcome are used to play the secondary game. Both primary and secondary outcomes are analyzed in regard to the rules of each game and a prize is awarded for each winning outcome.

### CROSS-REFERENCE TO RELATED APPLICATIONS

This application claims priority under 35USC§119(e) of U.S. provisional patent application No. 60/465,676, filed Apr. 28, 2003, the specification of which is hereby incorporated by reference.

### TECHNICAL FIELD

The present invention relates to a game of chance wherein a secondary game outcome is generated using elements from a primary game outcome.

### BACKGROUND OF THE INVENTION

Gambling has evolved a lot during the last few years, and game manufacturers are always searching for new methods to interest and entertain players. Players are always demanding more features and payouts.

Improvements in these kinds of games are desired to enhance the player's interest and entertainment.

### SUMMARY OF THE INVENTION

In an embodiment, the present invention provides a method of playing a game of chance wherein a secondary game is generated by duplicating and arranging according to the secondary game, a subset of primary game indicia coming from a primary game; and using at least one primary outcome element coming from conducting at least part of the primary game, to play the secondary game.

In another embodiment, the present invention provides a game apparatus comprising a display means to display a primary game in a structure characteristic to the primary game and a secondary game; a secondary game generating means duplicates and arranges, according to the secondary game, a subset of primary game indicia coming from the primary game; and random generating means to generate a primary outcome element; and a controller means using the primary outcome element to play the secondary game.

In yet another embodiment, the present invention provides a computer program embodied on a computer readable medium having codes adapted to provide game of chance wherein a secondary game is generated by duplicating and arranging according to the secondary game type, a subset of primary game indicia coming from a primary game; and using at least one primary outcome element coming from conducting at least part of the primary game, to play the secondary game.

In still another embodiment, the present invention provides a computer program carried on an electrical or electromagnetic carrier signal having codes adapted to provide a game of chance wherein a secondary game is generated by duplicating and arranging according to the secondary game type, a subset of primary game indicia coming from a primary game; and using at least one primary outcome element coming from conducting at least part of the primary game, to play the secondary game.

### BRIEF DESCRIPTION OF THE DRAWINGS

Further features and advantages of the present invention will become apparent from the following detailed description, taken in combination with the appended drawings, in which:

FIG. 1 is a schematic diagram showing a perspective view of a game machine suitable for the present invention;

FIG. 2 is a screen shot illustrating a bingo/keno example of the present invention;

FIG. 3 is a flow chart of a game process comprising a comparison step in accordance with an embodiment of the present invention;

FIG. 4 is a screen shot illustrating a line game/match game example of the present invention;

FIG. 5 is a flow chart of the a game process comprising a replacement step in accordance with an embodiment of the present invention;

FIG. 6 is a screen shot illustrating a line game/bingo example of the present invention;

FIG. 7 is a screen shot of part of a play of a poker/blackjack example of the present invention; and

FIG. 8 is a screen shot of the end of a play of a poker/blackjack example of the present invention.

It will be noted that throughout the appended drawings, like features are identified by like reference numerals.

### DETAILED DESCRIPTIONS OF THE PREFERRED EMBODIMENTS

The present invention describes a secondary game played along with a primary game of chance, said secondary game using, displaying, monitoring and evaluating a subset of the primary game indicia in a manner characteristic of the rules of said secondary game.

The primary game may be any kind of game wherein the outcome comprises a plurality of indicia, such as lotto, bingo, keno, poker, blackjack and line games. The secondary game may be any kind of game of chance having at least one indicia, including those mentioned earlier as well as a simple match game.

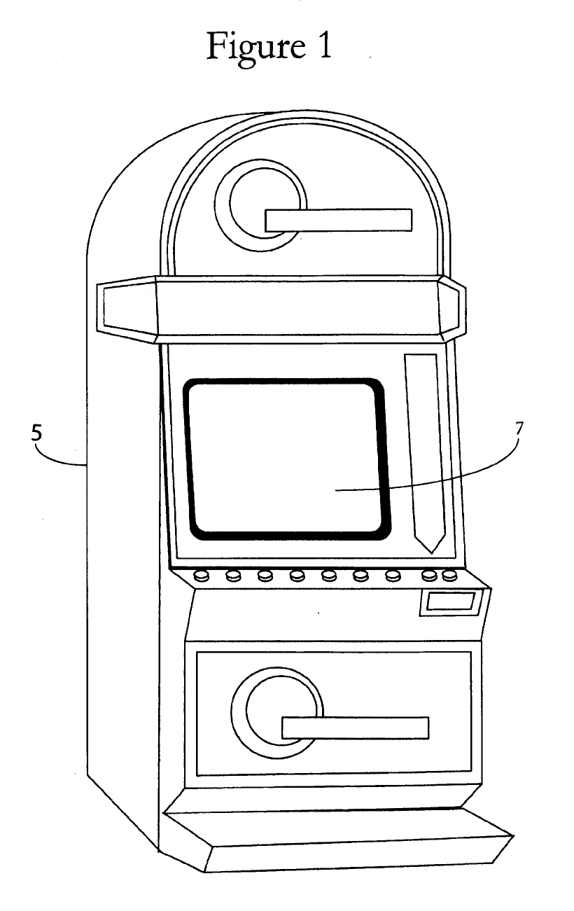

The present invention is preferably applied on a gaming machine 5, as illustrated in FIG. 1. Said gaming machine having a display means 7 to display the primary game and the secondary game, a subset generating means (not shown) to duplicate a subset of the primary game indicia, a random generating means (not shown) to generate primary outcome elements and a controller means (not shown) to play the secondary games using the primary outcome elements. The invention may also be applied in a computer program, or at a remote terminal, the game elements (not shown) being distributed via a network, such as linked machines or the internet, or broadcasted using an electrical or electro-magnetical signal.

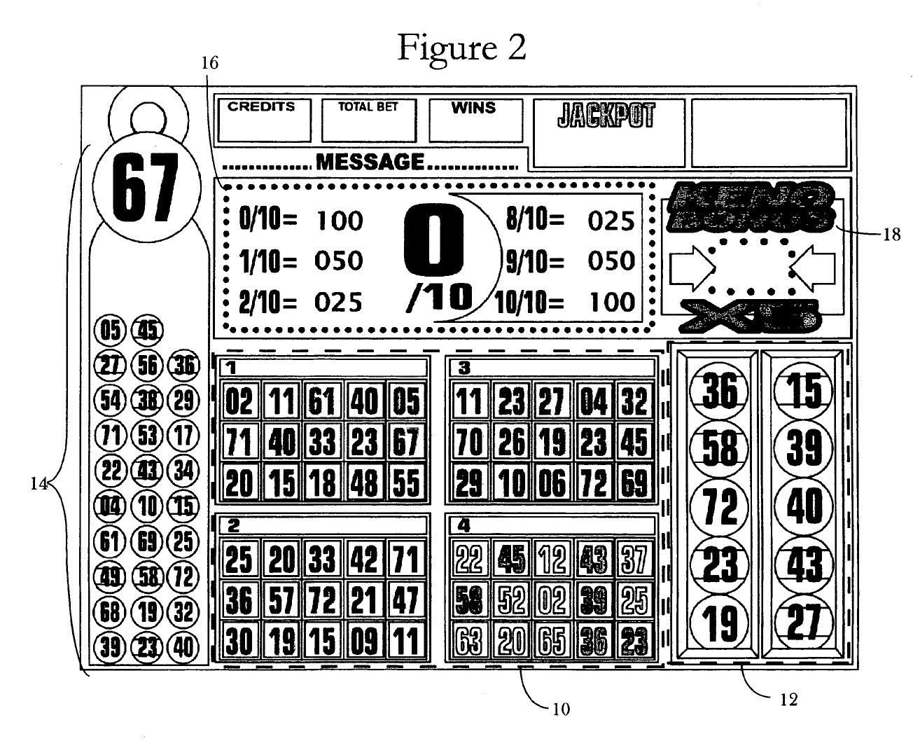

In a preferred embodiment, the primary game is bingo and the secondary game is keno, as illustrated in FIG. 2. The player is offered four (4) selectable bingo cards 10 each bearing fifteen numbers ranging from one (1) to seventy-five (75). The keno area presents the player with ten (10) keno numbers 12, which will be compared to the drawn numbers 14 to generate a keno secondary outcome. The drawn numbers are also compared to the bingo cards 10 to generate a bingo primary game outcome. A pay table 16 for the keno secondary game is also provided to the player. The accumulation of a predetermined number of wins in the keno secondary game also awards a “Keno Bonus” 18 in this example.

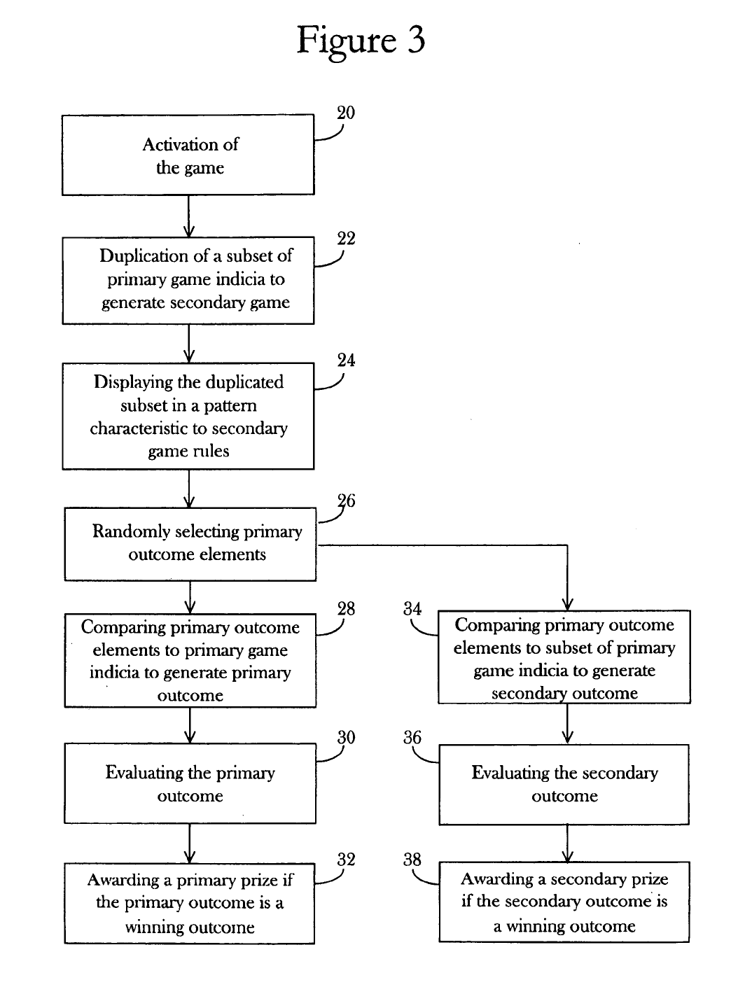

FIG. 3 explains the game process for a game wherein the primary outcome elements are compared to the primary game indicia to generate an outcome in the primary game, such as in the example illustrated in FIG. 2. Upon activation of the game by the player 20, a subset of the primary game indicia is duplicated to generate a secondary game 22, the subset of primary game indicia being displayed in a pattern characteristic to the secondary game rules 24. The primary outcome elements are then randomly selected 26 and compared to both the primary game indicia to generate a primary outcome 28 and the subset of primary game indicia of the secondary game to generate a secondary outcome 34. Both the primary outcome and the secondary outcome are evaluated 30 and 36 and a primary prize is awarded if the primary outcome is a winning outcome 32 and a secondary prize is awarded for a winning secondary outcome 38.

The process of FIG. 3 applied to the bingo/keno game shown in FIG. 2 is played as explained below. The player selects the bingo cards 10 he wishes to play on and pushes on the “Play” button to activate the game. The game device randomly duplicate ten (10) numbers from the played cards to the keno zone 12 on the game screen. Thirty numbers are randomly drawn and compared to both the bingo cards and the keno numbers. The bingo outcome (primary outcome) is evaluated according to bingo rules and a prize is awarded for any winning pattern formed on a card. The keno outcome (secondary outcome) is evaluated according to the number of matching numbers and thus to keno rules. In this example, the pay table respects the probabilities of winning such that, a low-probability outcome awards a bigger prize than a high-probability outcome. Since getting five out of ten matches is the most common outcome, it awards no prize. On the other hand, getting no match or ten out of ten are the least probable outcomes and thus both award the biggest prize.

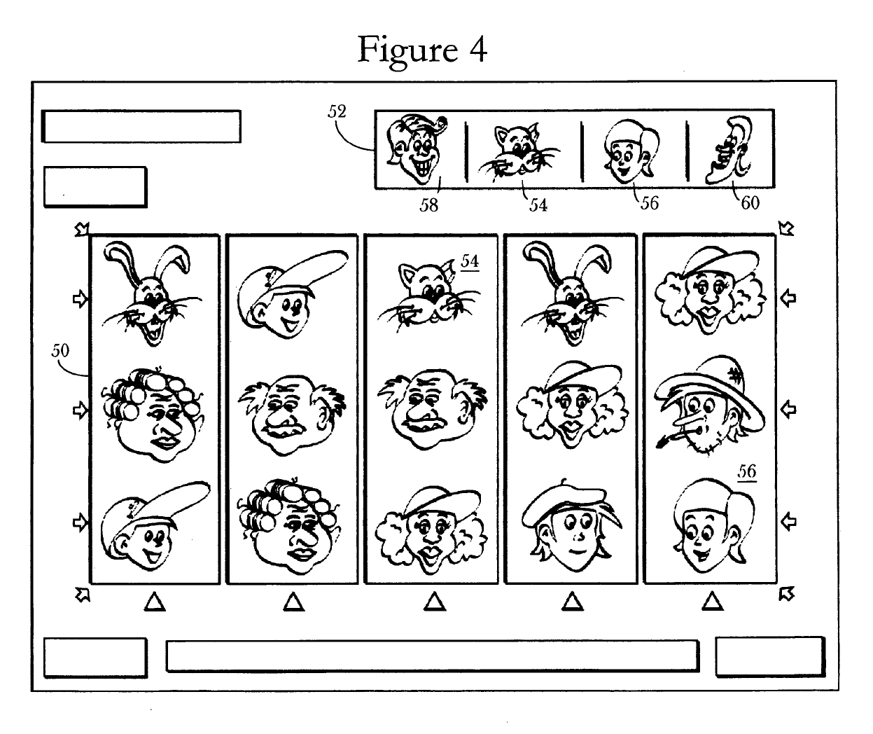

Another preferred embodiment is to offer a line game played along a match game as shown in FIG. 4. The line game 50 is the primary game and the match game 52 is the secondary game. A match game, as applied to this invention, is a game wherein the indicia of the secondary game are to be matched, regardless of the position or spatial organization of both the secondary game indicia and the primary outcome elements. For example, as shown on FIG. 4, the “Cat” symbol 54 and the “Girl” symbol 56 are both in the match game 52 and the line game 50, while the “Smiling Guy” 58 and “Moon Guy” 60 symbols of the match game 52 do not appear in the line game 50. In this example, the player would not be awarded a prize since only two (2) out of four (4) symbols of the secondary game match the primary outcome elements.

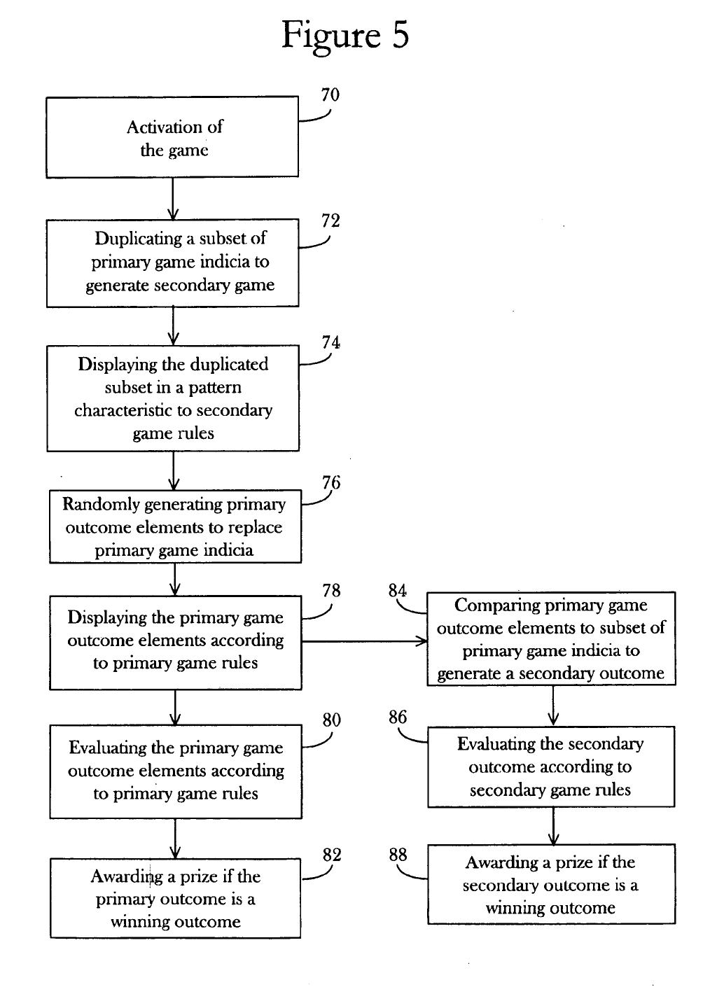

FIG. 5 explains the game process of an embodiment wherein the primary outcome elements replace the primary game indicia to generate an outcome in the primary game, such as in the example illustrated in FIG. 4. Since they are replaced during the primary game play, the primary game indicia are, in fact, the outcome elements from a precedent play. Upon actuation of the game 70 (the player pushes the “Play” button), a subset of the primary game indicia are duplicated to generate a secondary game 72, the subset of primary game indicia being displayed in a pattern characteristic to the secondary game rules 74. Primary outcome elements are randomly generated to replace the primary game indicia 76 and displayed according to the primary game rules 78. The primary outcome elements, constituting the primary outcome, are evaluated according to the primary game rules 80 and a primary prize is awarded for a winning primary outcome. At the same time, the primary outcome elements are compared to the subset of primary game indicia constituting the secondary game to generate a secondary outcome 84. The secondary outcome is evaluated according to the secondary game rules 86 and a prize is awarded for a winning secondary outcome 88.

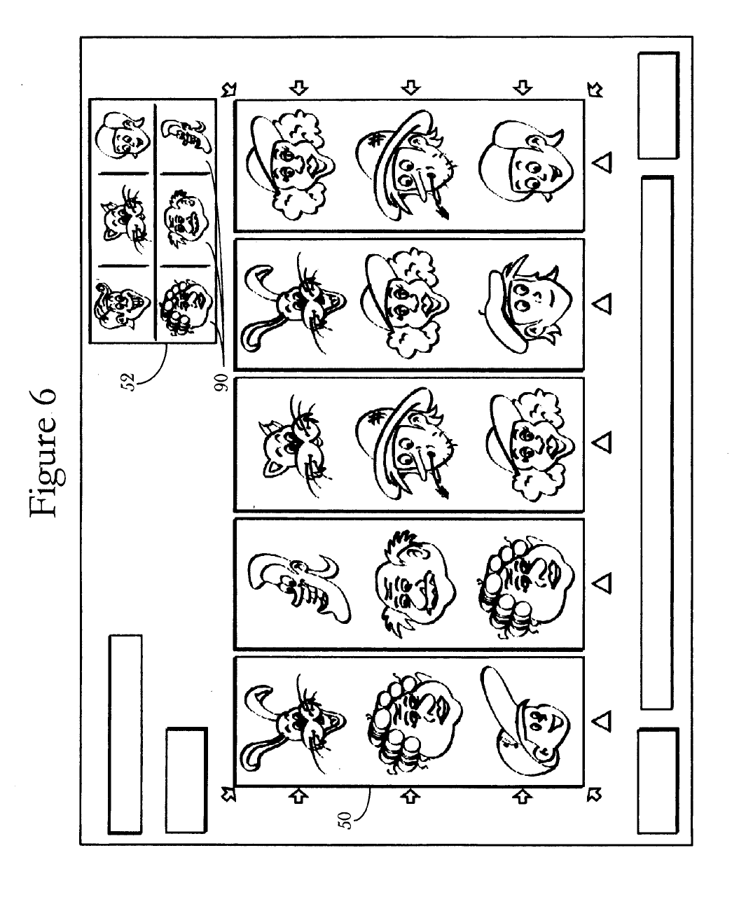

FIG. 6 illustrates such a game. The player has pushed the “Play” button and a subset of the precedent play has been duplicated in the secondary game zone 52, according to a bingo secondary game structure. The reels are spun and a primary outcome is formed 50 by replacing the primary game indicia (symbols on which the reels have stopped during the preceding spin) by the primary outcome elements (symbols on which the reels stop on the current spin). The symbols of the current spin are compared to the secondary game symbols and the matching symbols are marked. If all the symbols of a line are marked, or another winning bingo pattern is formed, the player is awarded the corresponding prize. The line game itself is evaluated and a prize is awarded to the player for each winning combination. In this example, all three (3) symbols of the second line 90 of the secondary game display 52 also appear in the line game 50, and thus a winning bingo pattern is borne by the secondary game.

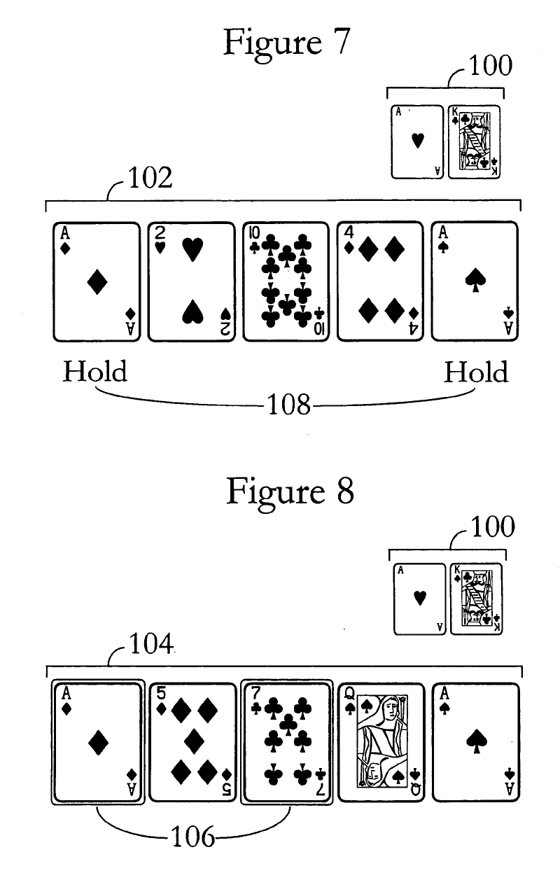

In some cases, as in the example illustrated in FIGS. 7 and 8, the primary game must be conducted to its completion before the primary outcome elements are generated. In this example, wherein the primary outcome elements replace the primary game indicia, the primary game is a draw poker game 102 and the secondary game is a blackjack game 100. As shown in FIG. 7, when the player pushes the “Play” button, two (2) of the cards from the final hand of the preceding play are duplicated in the secondary game zone; in this example, an Ace of Heart and a King of Club. An initial poker hand is dealt 102. The player holds the card 108 he wants to keep and new cards replace the discarded ones as illustrated in

FIG. 8. The final hand 104 is evaluated according to poker rules and the corresponding primary prize is awarded. Two (2) cards from this final hand 106 are randomly selected (primary outcome elements) and compared, according to blackjack rules, to the secondary game cards. If the secondary game cards have a higher total than the randomly selected in the poker hand, then the player is awarded a secondary prize. In this example, the player blackjack hand 100 has a total of twenty-one (21) while the game hand 106 has a total of eighteen (18). The player is awarded a secondary prize.

It should be noted that the present invention can be carried out as a method, can be embodied in a system, a computer readable medium or an electrical or electro-magnetical signal.

The embodiments of the invention described above are intended to be exemplary only. The scope of the invention is therefore intended to be limited solely by the scope of the appended claims.

We claim:

1. A method of playing a game of chance comprising the steps of:
providing a primary game comprising primary game indicia organized in a structure characteristic to said primary game;
duplicating a subset of said primary game indicia to generate a secondary game, said subset of primary game indicia being organized in a structure characteristic to said secondary game; and
conducting at least part of said primary game to generate a primary outcome element;
wherein said primary outcome element is used to play said secondary game.

2. The method of claim 1, wherein said primary outcome elements comprise one of (a) internal randomly selected indicia which, upon play of the game, replace said primary game indicia to generate a primary outcome; or (b) external randomly selected indicia which, upon play of the game, are compared to said primary game indicia to generate a primary outcome.

3. The method of claim 1, wherein conducting said primary game comprises using said primary outcome element to play said primary game to its completion to generate a primary outcome.

4. The method of claim 3, wherein conducting said primary game further comprises evaluating said primary outcome according to said primary game rules and awarding a primary prize for a winning primary outcome.

5. The method claim 1, wherein the play of said secondary game comprises generating a secondary outcome, evaluating said secondary outcome according to said secondary game rules and awarding a secondary for a winning secondary outcome.

6. The method of claim 1, wherein said primary game and said secondary game are of different types.

7. The method of claim 1, wherein said game indicia comprise at least one of cards, numbers and symbols.

8. The method of claim 1, wherein said primary game comprises at least one of poker, blackjack, bingo, lotto, keno and line game.

9. The method of claim 1, wherein said secondary game comprises at least one of poker, blackjack, bingo, lotto, keno, line game or match game.

10. A game apparatus comprising:
a display means to display a primary game comprising primary game indicia organized in a structure characteristic to said first type and to display a secondary game;
a subset generating means to duplicate a subset of said primary game indicia to generate said secondary game, said subset of primary game indicia being organized in a structure characteristic to said secondary game;
a random generating means to generate a primary outcome element;
a controller means to play said secondary game using said primary outcome element.

11. A computer program embodied on a computer readable medium having codes adapted to:
provide a primary game comprising primary game indicia organized in a structure characteristic to said primary game;
duplicate a subset of said primary game indicia to generate a secondary game, said subset of primary game indicia being organized in a structure characteristic to said secondary game; and
conduct at least part of said primary game to generate a primary outcome element;
wherein said primary outcome element is used to play said secondary game.

12. A computer program carried on an electrical or electromagnetic carrier signal having codes adapted to:
provide a primary game comprising primary game indicia organized in a structure characteristic to said primary game;
duplicate a subset of said primary game indicia to generate a secondary game, said subset of primary game indicia being organized in a structure characteristic to said secondary game; and
conduct at least part of said primary game to generate a primary outcome element;
wherein said primary outcome element is used to play said secondary game.
